(19) United States
(12) Patent Application Publication
(10) Pub. No.: US 2023/0011382 A1
(43) Pub. Date: Jan. 12, 2023

(54) OFF-FOCUS MICROSCOPIC IMAGES OF A SAMPLE

(71) Applicant: S.D. Sight Diagnostics Ltd., Tel Aviv (IL)

(72) Inventors: Dan GLUCK, Kadima (IL); Amir ZAIT, Binyamina (IL); Arnon HOURI YAFIN, Jerusalem (IL); Yonatan HALPERIN, Tel-Aviv Yafo (IL); Yochay Shlomo ESHEL, Sde Warburg (IL); Sarah LEVY, Jaffa (IL); Joseph Joel POLLAK, Neve Daniel (IL); Sharon PECKER, Rehov (IL); Peretz YAFIN, Kdumim (IL); Dana BENBASSAT, Tel Aviv (IL); David BRAILOVSKY, Hertzliya (IL); Uriyah PUMERANTZ, Tel Aviv (IL)

(73) Assignee: S.D. Sight Diagnostics Ltd., Tel Aviv (IL)

(21) Appl. No.: 17/783,831

(22) PCT Filed: Dec. 10, 2020
(86) PCT No.: PCT/IB2020/061728

§ 371 Date: Jun. 9, 2022

Related U.S. Application Data
(60) Provisional application No. 62/946,985, filed on Dec. 12, 2019.
(60) Provisional application No. 63/048,692, filed on Jul. 7, 2020.

(51) Int. Cl. G02B 21/00; G06T 7/00

(52) U.S. Cl. CPC G02B 21/006; G06T 7/0012; G06T 2207/30024; G06T 2207/10056

(57) ABSTRACT

Apparatus and methods are described use with a bodily sample that contains cells. A microscope (24) is focused, such that a focal plane of the microscope (24) at least approximately coincides with a level at which at least some cells belonging to the sample are at least partially disposed. At least one on-focus microscopic image of the sample, while the focal plane of the microscope (24) approximately coincides with the level. The microscope (24) is focused such that the focal plane of the microscope is offset with respect to the level, at least one off-focus microscopic image of the sample is acquired, while the focal plane of the microscope (24) is offset with respect to the level. A property of at least a portion of the sample is determined, at least partially based upon the on-focus and off-focus images. Other applications are also described.

### CROSS-REFERENCE TO RELATED APPLICATIONS

The present application claims priority from U.S. Provisional Patent Application No. 62/946,985 to Gluck et al., filed Dec. 12, 2019, and from U.S. Provisional Patent Application 63/048,692 to Gluck et al., filed Jul. 7, 2020, both entitled “Distinguishing between NRBCs and leukocytes,” both of which are incorporated herein by reference.

### FIELD OF EMBODIMENTS OF THE INVENTION

Some applications of the presently disclosed subject matter relate generally to analysis of bodily samples, and, in particular, to optical density and microscopic measurements that are performed upon blood samples.

### BACKGROUND

In some optics-based methods (e.g., diagnostic, and/or analytic methods), a property of a biological sample, such as a blood sample, is determined by performing an optical measurement. For example, the density of a component (e.g., a count of the component per unit volume) may be determined by counting the component within a microscopic image. Similarly, the concentration and/or density of a component may be measured by performing optical absorption, transmittance, fluorescence, and/or luminescence measurements upon the sample. Typically, the sample is placed into a sample carrier and the measurements are performed with respect to a portion of the sample that is contained within a sample chamber of the sample carrier. The measurements that are performed upon the portion of the sample that is contained within the sample chamber of the sample carrier are analyzed in order to determine a property of the sample.

Mammalian red blood cells (i.e., erythrocytes) are the body's carriers of oxygen. During their maturation process red blood cells undergo de-nucleation, i.e., complete removal of the nucleus from the cell. Normally, nucleated red blood cells (NRBCs) are not found in peripheral blood of adult patients. However, in some conditions (such as newborns, oncology patient, anemia patients, etc.) NRBCs are found in peripheral blood.

### SUMMARY OF EMBODIMENTS

As described hereinabove in the Background section, mammalian red blood cells are the body's carriers of oxygen. During their maturation process red blood cells undergo de-nucleation, i.e., complete removal of the nucleus from the cell. Normally, nucleated red blood cells (NRBCs) are not found in peripheral blood of adult patients. However, in some conditions (such as newborns, oncology patient, anemia patients, etc.) NRBCs are found in peripheral blood. As NRBCs are similar in size and nucleus content to some leukocytes (and, particularly, lymphocytes), it is typically difficult to distinguish between NRBCs and leukocytes. In some applications of the present invention, a complete blood count is performed upon a blood sample. In the context of a complete blood count, it is typically important to differentiate between NRBCs and leukocytes, in order to avoid overcounting leukocytes (particularly in patients having a low leukocyte count) and in order to detect the presence of NRBCs (which may be indicative of an underlying condition).

In accordance with some applications of the present invention, in order to distinguish between a leukocyte (e.g., a lymphocyte) and an NRBC (e.g., in a situation in which an NRBC/leukocyte candidate (i.e., a candidate which may be either an NRBC or a leukocyte) was detected), a microscope image is acquired while the sample is illuminated with light having a wavelength at which hemoglobin has a high level of absorption. Typically, violet light, e.g., light having a wavelength within the range of more than 400 nm and/or less than 450 nm (e.g., 400-450 nm) is used. (It is noted that there is some variation within the literature regarding the range of wavelengths that are referred to as being within the violet range. For the purpose of the present application, violet light should be interpreted as including light within the range of 400-450 nm.) Within this wavelength range, the absorption of hemoglobin is relatively high, compared to other wavelengths within the visible spectrum. Typically, NRBCs have a high hemoglobin content (of the order of 30 picogram per cell), while leukocytes contain no hemoglobin. Therefore, within the images that are acquired under the violet light illumination, NRBCs typically absorb light, whereas leukocytes do not.

Typically, at least partially based upon the intensity of an NRBC/leukocyte candidate within an image that is acquired under violet light illumination, then the NRBC/leukocyte candidate is classified as being either an NRBC or a leukocyte. For some applications, an intensity threshold is applied to the image acquired under violet lighting conditions (and/or to given regions or pixels thereof), and the NRBC/leukocyte candidate is classified as either being either an NRBC or a leukocyte based upon whether or not the intensity of the NRBC/leukocyte candidate passes the threshold.

For some applications, generally similar techniques to those described above are performed, but light having a wavelength of more than 500 nm and/or less than 600 nm (e.g., 500-600 nm) is used. Within this wavelength range, the absorption of carbaminohemoglobin is relatively high, compared to other wavelengths within the visible spectrum.

In accordance with some applications of the present invention, a portion of a blood sample that comprises a cell suspension is placed within a sample chamber of a carrier, the sample chamber being a cavity that includes a base surface. Typically, the cells in the cell suspension are allowed to settle on the base surface of the sample chamber to form a monolayer of cells on the base surface of the sample chamber. Subsequent to the cells having been left to settle on the base surface of the sample chamber (e.g., by having been left to settle for a predefined time interval), at least one microscopic image of at least a portion of the monolayer of cells is typically acquired.

For some applications, in addition to acquiring images with the microscope focal plane set to approximately coincide with the monolayer focus level (such images being referred to herein as “on-focus” images), the microscope acquires images with the microscope focal plane set to be offset along the optical axis with respect to the monolayer focal level (such images being referred to herein as “off-focus” images). Typically, such off-focus microscopic images are acquired with the focal plane of the microscope set closer to the objective lens of the microscope than the monolayer focus level, although the scope of the present invention includes acquiring off-focus images with the focal plane of the microscope set farther from the objective lens of the microscope than the monolayer focus level. For some applications, the off-focus microscopic images are acquired with the focal plane of the microscope set at an offset with respect to the monolayer focus level of more than 20 microns and/or less than 100 microns, e.g., 20-100 microns. Alternatively or additionally, the off-focus microscopic images are acquired with the focal plane of the microscope set at an offset with respect to the monolayer focus level of more than one times the focal depth of the microscope, and/or less than five times the focal depth of the microscope, e.g., between one focal depth and five focal depths of the microscope.

The inventors of the present application have found that such off-focus microscopic images can generate important data regarding a sample. In particular, off-focus images are typically used to identify the outlines of cells, and/or to identify certain entities within a sample, such as leukocytes, leukocyte types (e.g., lymphocytes, granulocytes, monocytes, neutrophils, banded neutrophils, eosinophils, basophils, macrophages, and/or blast cells), red blood cells, red blood cell types (e.g., mature red blood cell, NRBC, echinocyte, sickle cell, tear-drop cell), and/or platelets. For some applications, off-focus images are used to enhance the visibility of such entities with respect to other entities, such that they may be identified with a greater degree of certainty. Alternatively or additionally, off-focus images are used to make such entities more easily distinguishable from other entities to which they might otherwise be confused. For some applications, off-focus images are used to characterize features of cells, such as hemoglobin content of red blood cells, other components of red blood cells, and/or maturity of a cell (such as a neutrophil).

There is therefore provided, in accordance with some applications of the present invention, a method for use with a bodily sample that contains cells, the method including:

focusing a microscope such that a focal plane of the microscope at least approximately coincides with a level at which at least some cells belonging to the sample are at least partially disposed;

acquiring at least one on-focus microscopic image of the sample, while the focal plane of the microscope approximately coincides with the level;

focusing the microscope such that the focal plane of the microscope is offset with respect to the level;

acquiring at least one off-focus microscopic image of the sample, while the focal plane of the microscope is offset with respect to the level; and

determining a property of at least a portion of the sample, at least partially based upon the on-focus and off-focus images.

In some applications, acquiring at least one off-focus microscopic image of the sample while the focal plane of the microscope is offset with respect to the level includes acquiring at least one off-focus microscopic image of the sample while the focal plane of the microscope is offset with respect to the level by a predetermined offset.

In some applications, determining a property of at least a portion of the sample at least partially based upon the on-focus and off-focus image includes inputting the on-focus and off-focus image into a machine-learning classifier, the machine-learning classifier being configured to determine a property of at least a portion of the sample at least partially based upon the on-focus and off-focus image.

In some applications, determining a property of at least a portion of the sample at least partially based upon the on-focus and off-focus image includes deriving one or more parameters from the on-focus and off-focus image and inputting the one or more derived parameters into a machine-learning classifier, the machine-learning classifier being configured to determine a property of at least a portion of the sample at least partially based upon the derived parameters.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 505 nm and 535 nm.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 400 nm and 450 nm.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 620 nm and 640 nm.

In some applications, focusing the microscope such that the focal plane of the microscope is offset with respect to the level includes focusing the microscope such that the focal plane of the microscope is set closer to an objective lens of the microscope than the level at which at least some cells belonging to the sample are at least partially disposed.

In some applications, focusing the microscope such that the focal plane of the microscope is offset with respect to the level includes focusing the microscope such that the focal plane of the microscope is set farther from an objective lens of the microscope than the level at which at least some cells belonging to the sample are at least partially disposed.

In some applications, focusing the microscope such that the focal plane of the microscope is offset with respect to the level includes focusing the microscope such that the focal plane of the microscope is offset with respect to the level at which at least some cells belonging to the sample are at least partially disposed by between 20 microns and 100 microns.

In some applications, focusing the microscope such that the focal plane of the microscope is offset with respect to the level includes focusing the microscope such that the focal plane of the microscope is offset with respect to the level at which at least some cells belonging to the sample are at least partially disposed by between one and five depths of focus of the microscope.

In some applications, the method further includes allowing some cells within the sample to settle such as to form a monolayer at a monolayer focus level, focusing the microscope such that the focal plane of the microscope at least approximately coincides with a level at which at least some cells belonging to the sample are at least partially disposed includes focusing the microscope such that the focal plane of the microscope at least approximately coincides with the monolayer focus level.

In some applications, the method further includes allowing some cells within the sample to settle such as to form a monolayer at a monolayer focus level, with other cells within the sample suspended at at least one additional level within the sample, focusing the microscope such that the focal plane of the microscope at least approximately coincides with a level at which at least some cells belonging to the sample are at least partially disposed includes focusing the microscope such that the focal plane of the microscope at least approximately coincides with the additional level at which the other cells within the sample are suspended.

In some applications, determining the property of the portion of the sample, at least partially based upon the on-focus and off-focus image includes normalizing the on-focus and off-focus image with respect to each other and determining the property of the portion of the sample, at least partially based upon the normalization.

In some applications, the sample includes a blood sample, and determining the property of the portion of the sample at least partially based upon the on-focus and off-focus image includes identifying one or more entities within the blood sample at least partially based upon the on-focus and off-focus image, the one or more entities selected from the group consisting of: a platelet, a leukocyte, a lymphocyte, a granulocyte, a monocyte, a neutrophil, a banded neutrophil, an eosinophil, a basophil, and a macrophage.

In some applications, the sample includes a blood sample, and determining the property of the portion of the sample at least partially based upon the on-focus and off-focus image includes identifying a blast cell within the blood sample at least partially based upon the on-focus and off-focus image.

In some applications, determining the property of the portion of the sample at least partially based upon the on-focus and off-focus image includes identifying outlines of one or more entities within the sample at least partially based upon the on-focus and off-focus image.

In some applications, determining the property of the portion of the sample at least partially based upon the on-focus and off-focus image further includes estimating a parameter of the one or more entities at least partially based upon the identified outlines, the parameters selected from the group consisting of: cell area and cell volume.

In some applications, determining the property of the portion of the sample at least partially based upon the on-focus and off-focus image further includes estimating a parameter of sample at least partially based upon the identified outlines, the at least one parameter selected from the group consisting of: mean cell area and mean cell volume.

There is further provided, in accordance with some applications of the present invention, apparatus for use with a bodily sample that contains cells, the apparatus including:

a microscope; and

a computer processor configured to:
focus the microscope such that a focal plane of the microscope at least approximately coincides with a level at which at least some cells belonging to the sample are at least partially disposed,
   drive the microscope to acquire at least one on-focus microscopic image of the sample, while the focal plane of the microscope approximately coincides with the level,
   focus the microscope such that the focal plane of the microscope is offset with respect to the level,
   drive the microscope to acquire at least one off-focus microscopic image of the sample, while the focal plane of the microscope is offset with respect to the level, and

determine a property of at least a portion of the sample, at least partially based upon the on-focus and off-focus images.

There is further provided, in accordance with some applications of the present invention, a method for use with a bodily sample that contains cells, the method including:

focusing the microscope such that the focal plane of the microscope is offset with respect to a level at which at least some cells belonging to the sample are at least partially disposed;

acquiring at least one off-focus microscopic image of the sample, while the focal plane of the microscope is offset with respect to the level; and

at least partially based upon the off-focus image, performing one or more actions selected from the group consisting of: identifying an entity disposed within the level, determining outlines of an entity disposed within the level, determining a parameter of an entity disposed within the level, determining a parameter of the sample, and any combination thereof.

In some applications, acquiring at least one off-focus microscopic image of the sample while the focal plane of the microscope is offset with respect to the level includes acquiring at least one off-focus microscopic image of the sample while the focal plane of the microscope is offset with respect to the level by a predetermined offset.

In some applications, performing the one or more actions at least partially based upon the off-focus image includes inputting the off-focus image into a machine-learning classifier, the machine-learning classifier being configured to performing the one or more actions at least partially based upon the off-focus image.

In some applications, performing the one or more actions at least partially based upon the off-focus image includes deriving one or more parameters from the off-focus image and inputting the one or more derived parameters into a machine-learning classifier, the machine-learning classifier being configured to perform the one or more actions at least partially based upon the derived parameters.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 505 nm and 535 nm.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 400 nm and 450 nm.

In some applications, the sample includes a blood sample, and acquiring at least one off-focus microscopic image of the sample while the focal plane of the microscope is offset with respect to the level includes acquiring at least one off-focus microscopic image of the sample with the sample illuminated with light having a wavelength of between 620 nm and 640 nm.

In some applications, focusing the microscope such that the focal plane of the microscope is offset with respect to the level includes focusing the microscope such that the focal plane of the microscope is set closer to an objective lens of the microscope than the level at which at least some cells belonging to the sample are at least partially disposed.

In some applications, focusing the microscope such that the focal plane of the microscope is offset with respect to the level includes focusing the microscope such that the focal plane of the microscope is set farther from an objective lens of the microscope than the level at which at least some cells belonging to the sample are at least partially disposed.

In some applications, focusing the microscope such that the focal plane of the microscope is offset with respect to the level includes focusing the microscope such that the focal plane of the microscope is offset with respect to the level at which at least some cells belonging to the sample are at least partially disposed by between 20 microns and 100 microns.

In some applications, focusing the microscope such that the focal plane of the microscope is offset with respect to the level includes focusing the microscope such that the focal plane of the microscope is offset with respect to the level at which at least some cells belonging to the sample are at least partially disposed by between one and five depths of focus of the microscope.

In some applications, the method further includes allowing some cells within the sample to settle such as to form a monolayer at a monolayer focus level, focusing the microscope such that the focal plane of the microscope is offset with respect to the level includes focusing the microscope such that the focal plane of the microscope is offset with respect to the monolayer focus level.

In some applications, the method further includes allowing some cells within the sample to settle such as to form a monolayer at a monolayer focus level, with other cells within the sample suspended at at least one additional level within the sample, focusing the microscope such that the focal plane of the microscope is offset with respect to the level includes focusing the microscope such that the focal plane of the microscope is offset with respect to the additional level at which the other cells within the sample are suspended.

In some applications, determining the property of the portion of the sample, at least partially based upon the off-focus image includes normalizing the off-focus image with respect to another image and determining the property of the portion of the sample, at least partially based upon the normalization.

In some applications, the sample includes a blood sample, and determining the property of the portion of the sample at least partially based upon the off-focus image includes identifying one or more entities within the blood sample at least partially based upon the off-focus image, the one or more entities selected from the group consisting of: a platelet, a leukocyte, a lymphocyte, a granulocyte, a monocyte, a neutrophil, a banded neutrophil, an eosinophil, a basophil, and a macrophage.

In some applications, the sample includes a blood sample, and determining the property of the portion of the sample at least partially based upon the off-focus image includes identifying a blast cell within the blood sample at least partially based upon the off-focus image.

In some applications, determining the property of the portion of the sample at least partially based upon the off-focus image includes identifying outlines of one or more entities within the sample at least partially based upon the off-focus image.

In some applications, determining the property of the portion of the sample at least partially based upon the off-focus image further includes estimating a parameter of the one or more entities at least partially based upon the identified outlines, the parameters selected from the group consisting of: cell area and cell volume.

In some applications, determining the property of the portion of the sample at least partially based upon the off-focus image further includes estimating a parameter of sample at least partially based upon the identified outlines, the at least one parameter selected from the group consisting of: mean cell area and mean cell volume.

There is further provided, in accordance with some applications of the present invention, apparatus for use with a bodily sample that contains cells, the apparatus comprising:

a microscope; and

a computer processor configured to:
focus the microscope such that the focal plane of the microscope is offset with respect to a level at which at least some cells belonging to the sample are at least partially disposed,
   drive the microscope to acquire at least one off-focus microscopic image of the sample, while the focal plane of the microscope is offset with respect to the level, and

at least partially based upon the off-focus image, perform one or more actions selected from the group consisting of: identifying an entity disposed within the level, determining outlines of an entity disposed within the level, determining a parameter of an entity disposed within the level, determining a parameter of the sample, and any combination thereof.

There is further provided, in accordance with some applications of the present invention, a method for use with a bodily sample that contains cells, the method including:

focusing a microscope such that a focal plane of the microscope at least approximately coincides with a level at which at least some cells belonging to the sample are at least partially disposed;

acquiring at least one on-focus microscopic image of the sample, while the focal plane of the microscope approximately coincides with the level;

focusing the microscope such that the focal plane of the microscope is offset with respect to the level;

acquiring at least one off-focus microscopic image of the sample, while the focal plane of the microscope is offset with respect to the level by a predetermined offset; and

verifying that, in the on-focus image, the focal plane of the microscope coincides with the level, by analyzing the on-focus image and the off-focus images.

There is further provided, in accordance with some applications of the present invention, apparatus for use with a bodily sample that contains cells, the apparatus comprising:

a microscope; and

a computer processor configured to:
focus the microscope such that a focal plane of the microscope at least approximately coincides with a level at which at least some cells belonging to the sample are at least partially disposed,
drive the microscope to acquire at least one on-focus microscopic image of the sample, while the focal plane of the microscope approximately coincides with the level;
focus the microscope such that the focal plane of the microscope is offset with respect to the level,
drive the microscope to acquire at least one off-focus microscopic image of the sample, while the focal plane of the microscope is offset with respect to the level by a predetermined offset, and
verify that, in the on-focus image, the focal plane of the microscope coincides with the level, by analyzing the on-focus image and the off-focus images.

There is further provided, in accordance with some applications of the present invention, a method for use with a blood sample, including:

identifying an NRBC/leukocyte candidate within one or more microscopic images of the blood sample, based upon the NRBC/leukocyte candidate having characteristics that indicate that the NRBC/leukocyte candidate may be either an NRBC or a leukocyte;

identifying the NRBC/leukocyte candidate within a microscopic image that was acquired under illumination by light in a wavelength range of between 400 nm and 450 nm and/or between 500 nm and 600 nm;

at least partially based upon a level of light absorption by the NRBC/leukocyte candidate within the microscopic image that was acquired under illumination by light in a wavelength range of between 400 nm and 450 nm and/or between 500 nm and 600 nm, classifying the NRBC/leukocyte candidate as being either an NRBC or a leukocyte; and

generating an output, at least partially based upon the classification of the NRBC/leukocyte candidate as an NRBC or a leukocyte.

In some applications:

identifying the NRBC/leukocyte candidate within a microscopic image that was acquired under illumination by light in a wavelength range of between 400 nm and 450 nm and/or between 500 nm and 600 nm includes identifying the NRBC/leukocyte candidate within a violet microscopic image that was acquired under illumination by violet light in a wavelength range of between 400 nm and 450 nm; and

classifying the NRBC/leukocyte candidate as being either an NRBC or a leukocyte includes classifying the NRBC/leukocyte candidate as being either an NRBC or a leukocyte at least partially based upon a level of light absorption by the NRBC/leukocyte candidate within the violet microscopic image that was acquired under illumination by light in a wavelength range of between 400 nm and 450 nm.

In some applications, classifying the NRBC/leukocyte candidate as being either an NRBC or a leukocyte includes applying an intensity threshold to the violet microscopic image, and classifying the NRBC/leukocyte candidate as being a leukocyte based upon the intensity of the candidate passing the threshold.

In some applications, the method further includes, in response to detecting the NRBC/leukocyte candidate selecting to acquire the violet microscopic image of an imaging field in which the NRBC/leukocyte candidate is present.

In some applications, classifying the NRBC/leukocyte candidate as being either an NRBC or a leukocyte further includes analyzing one or more additional features of the candidate selected from the group consisting of: a size of the candidate, a size of a nucleus of the candidate, an intensity of the candidate in a fluorescent image, an intensity of a cytoplasm of the candidate, an area of a cytoplasm of the candidate, ellipticity of the candidate, ellipticity of a nucleus of the candidate, roundness of a nucleus of the candidate, and a combination thereof.

In some applications, the method further includes, in response to a concentration of NRBCs that are detected within the blood sample passing a threshold, adjusting a detection-threshold for detecting NRBCs within the blood sample, such as to increase sensitivity of NRBC detection.

In some applications, the method further includes, in response to a concentration of NRBCs that are detected within the blood sample passing a threshold, adjusting a detection threshold for detecting one or more entities other than NRBCs within the blood sample.

In some applications, the method further includes, in response to a concentration of NRBCs that are detected within the blood sample passing a first threshold and a count of leukocytes within the sample being less than a second threshold, re-analyzing at least some of the NRBC/leukocyte candidates.

In some applications, the method further includes, in response to a concentration of NRBCs that are detected within the blood sample passing a first threshold and a count of leukocytes within the sample being less than a second threshold, generating an output indicating that an NRBC count may be erroneous.

In some applications, the method further includes, in response to a concentration of NRBCs that are detected within the blood sample passing a first threshold and a count of leukocytes within the sample being less than a second threshold, generating an output indicating that a leukocyte count may be erroneous.

In some applications, the method further includes, in response to a concentration of NRBCs that are detected within the blood sample passing a first threshold and a count of a given type of leukocytes within the sample being less than a second threshold, generating an output indicating that a count of the given type of leukocytes may be erroneous.

There is further provided, in accordance with some applications of the present invention, apparatus for use with a blood sample, including:

a microscope configured to acquire microscopic images of the blood sample; and

a computer processor configured to:
identifying an NRBC/leukocyte candidate within one or more of microscopic images of the blood sample, based upon the NRBC/leukocyte candidate having characteristics that indicate that the NRBC/leukocyte candidate may be either an NRBC or a leukocyte;
identify the NRBC/leukocyte candidate within a microscopic image that was acquired under illumination by light in a wavelength range of between 400 nm and 450 nm and/or between 500 nm and 600 nm;
at least partially based upon a level of light absorption by the NRBC/leukocyte candidate within the microscopic image that was acquired under illumination by light in a wavelength range of between 400 nm and 450 nm and/or between 500 nm and 600 nm, classify the NRBC/leukocyte candidate as being either an NRBC or a leukocyte; and

generate an output, at least partially based upon the classification of the NRBC/leukocyte candidate as an NRBC or a leukocyte.

There is therefore provided, in accordance with some applications of the present invention, a method for use with a blood sample, including:

identifying an NRBC/leukocyte candidate within one or more microscopic images of the blood sample, based upon the NRBC/leukocyte candidate having characteristics that indicate that the NRBC/leukocyte candidate may be either an NRBC or a leukocyte;

identifying the NRBC/leukocyte candidate within a violet microscopic image that was acquired under illumination by violet light in a wavelength range of between 400 nm and 450 nm;

at least partially based upon a level of light absorption by the NRBC/leukocyte candidate within the violet microscopic image, classifying the NRBC/leukocyte candidate as being either an NRBC or a leukocyte; and

generating an output, at least partially based upon the classification of the NRBC/leukocyte candidate as an NRBC or a leukocyte.

For some applications, classifying the NRBC/leukocyte candidate as being either an NRBC or a leukocyte includes applying an intensity threshold to the violet microscopic image, and classifying the NRBC/leukocyte candidate as being a leukocyte based upon the intensity of the candidate passing the threshold.

For some applications, the method further includes, in response to detecting the NRBC/leukocyte candidate selecting to acquire a violet microscopic image of an imaging field in which the NRBC/leukocyte candidate is present.

For some applications, classifying the NRBC/leukocyte candidate as being either an NRBC or a leukocyte further includes analyzing one or more additional features of the candidate selected from the group consisting of: a size of the candidate, a size of a nucleus of the candidate, an intensity of the candidate in a fluorescent image, an intensity of a cytoplasm of the candidate, an area of a cytoplasm of the candidate, ellipticity of the candidate, ellipticity of a nucleus of the candidate, roundness of a nucleus of the candidate, and a combination thereof.

For some applications, the method further includes, in response to a concentration of NRBCs that are detected within the blood sample passing a threshold, adjusting a detection-threshold for detecting NRBCs within the blood sample, such as to increase sensitivity of NRBC detection.

For some applications, the method further includes, in response to a concentration of NRBCs that are detected within the blood sample passing a threshold, adjusting a detection threshold for detecting one or more entities other than NRBCs within the blood sample.

For some applications, the method further includes, in response to a concentration of NRBCs that are detected within the blood sample passing a first threshold and a count of leukocytes within the sample being less than a second threshold, re-analyzing at least some of the NRBC/leukocyte candidates.

For some applications, the method further includes, in response to a concentration of NRBCs that are detected within the blood sample passing a first threshold and a count of leukocytes within the sample being less than a second threshold, generating an output indicating that an NRBC count may be erroneous.

For some applications, the method further includes, in response to a concentration of NRBCs that are detected within the blood sample passing a first threshold and a count of leukocytes within the sample being less than a second threshold, generating an output indicating that a leukocyte count may be erroneous.

For some applications, the method further includes, in response to a concentration of NRBCs that are detected within the blood sample passing a first threshold and a count of a given type of leukocytes within the sample being less than a second threshold, generating an output indicating that a count of the given type of leukocytes may be erroneous.

There is further provided, in accordance with some applications of the present invention, a method for use with a blood sample, including:

acquiring at least one violet microscopic image of the sample, under illumination of the sample by violet light in a wavelength range of between 400 nm and 450 nm;

identifying red blood cells within the at least one violet microscopic image of the sample;

determining statistical hemoglobin-related properties of the sample, based upon the red blood cells identified within the at least one violet microscopic image of the sample; and

generating an output, at least partially based upon the determined statistical hemoglobin-related properties of the sample.

There is additionally provided, in accordance with some applications of the present invention, a method for use with a blood sample, including:

identifying an NRBC/leukocyte candidate within one or more microscopic images of the blood sample, based upon the NRBC/leukocyte candidate having characteristics that indicate that the NRBC/leukocyte candidate may be either an NRBC or a leukocyte;

identifying the NRBC/leukocyte candidate within a microscopic image that was acquired under illumination by light in a wavelength range of between 500 nm and 600 nm;

at least partially based upon a level of light absorption by the NRBC/leukocyte candidate within the microscopic image, classifying the NRBC/leukocyte candidate as being either an NRBC or a leukocyte; and

generating an output, at least partially based upon the classification of the NRBC/leukocyte candidate as an NRBC or a leukocyte.

There is further provided, in accordance with some applications of the present invention, a method for use with a blood sample, including:

acquiring at least one microscopic image of the sample, under illumination of the sample by light in a wavelength range of between 500 nm and 600 nm;

identifying red blood cells within the at least one microscopic image of the sample;

determining statistical hemoglobin-related properties of the sample, based upon the red blood cells identified within the at least one microscopic image of the sample; and

generating an output, at least partially based upon the determined statistical hemoglobin-related properties of the sample.

The present invention will be more fully understood from the following detailed description of embodiments thereof, taken together with the drawings, in which:

### BRIEF DESCRIPTION OF THE DRAWINGS

FIG. 1 is a block diagram showing components of a biological sample analysis system, in accordance some applications of the present invention;

FIGS. 2A, 2B, and 2C are schematic illustrations of an optical measurement unit, in accordance with some applications of the present invention;

FIGS. 3A, 3B, and 3C are schematic illustrations of respective views of a sample carrier that is used for performing both microscopic measurements and optical density measurements, in accordance with some applications of the present invention;

FIG. 4A is a microscopic image of an entity that is NRBC/leukocyte candidate, in accordance with some applications of the present invention;

FIG. 4B is a microscopic image of an NRBC that is acquired under violet illumination conditions, in accordance with some applications of the present invention;

FIG. 4C is a microscopic image of a leukocyte that is acquired under violet illumination conditions, in accordance with some applications of the present invention;

FIG. 5, is a flowchart showing steps of a method that is performed with respect to NRBC/leukocyte candidates identified within one or more microscopic images of a blood sample, in accordance with some applications of the present invention;

FIGS. 6A, 6B, and 6C are microscopic images of a red blood cell that are acquired under, respectively, red, green, and violet illumination condition, in accordance with some applications of the present invention;

FIG. 7 is a flowchart showing steps of a method that is performed with respect to red blood cells identified within one or more microscopic images of a blood sample, in accordance with some applications of the present invention;

FIG. 8 is a flowchart showing steps of a method for use with a bodily sample that contains cells, in accordance with some applications of the present invention;

FIGS. 9A and 9B are examples of brightfield microscopic images of a monolayer of cells of a blood sample that were acquired using violet illumination with the microscope focal plane set, respectively, to coincide with the monolayer of cells (FIG. 9A), and with the microscope focal plane set to be off-focus with respect to the monolayer of cells (FIG. 9B), in accordance with some applications of the present invention;

FIG. 9C is a fluorescent microscopic image of the same portion of the sample as shown in FIGS. 9A and 9B, after staining the sample with Acridine Orange and with a Hoechst reagent and exciting the sample with UV light, such that the platelet fluoresces, in accordance with some applications of the present invention;

FIGS. 10A and 10B are examples of brightfield microscopic images of a monolayer of cells of a blood sample that were acquired using violet illumination with the microscope focal plane set, respectively, to coincide with the monolayer of cells (FIG. 10A), and with the microscope focal plane set to be off-focus with respect to the monolayer of cells (FIG. 10B), in accordance with some applications of the present invention;

FIGS. 11A and 11B are examples of brightfield microscopic images of a monolayer of cells of a blood sample that were acquired using green illumination with the microscope focal plane set, respectively, to coincide with the monolayer of cells (FIG. 11A), and with the microscope focal plane set to be off-focus with respect to the monolayer of cells (FIG. 11B), in accordance with some applications of the present invention; and

FIGS. 12A, 12B, and 12C are examples of brightfield microscopic images of a monolayer of cells of a blood sample that were acquired using green illumination with the microscope focal plane set, respectively, to coincide with the monolayer of cells (FIG. 12A), and with the microscope focal plane set to be off-focus with respect to the monolayer of cells (FIGS. 12B and 12C), in accordance with some applications of the present invention.

### DETAILED DESCRIPTION OF EMBODIMENTS

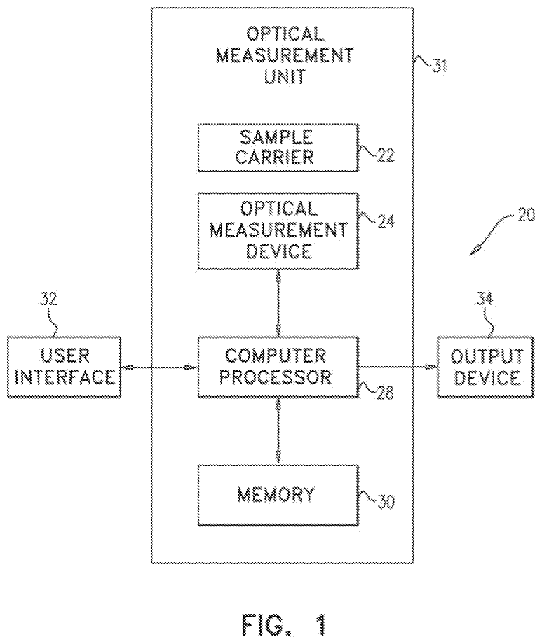

Reference is now made to FIG. 1A, which is block diagram showing components of a biological sample analysis system 20, in accordance with some applications of the present invention. Typically, a biological sample (e.g., a blood sample) is placed into a sample carrier 22. While the sample is disposed in the sample carrier, optical measurements are performed upon the sample using one or more optical measurement devices 24. For example, the optical measurement devices may include a microscope (e.g., a digital microscope), a spectrophotometer, a photometer, a spectrometer, a camera, a spectral camera, a hyperspectral camera, a fluorometer, a spectrofluorometer, and/or a photodetector (such as a photodiode, a photoresistor, and/or a phototransistor). For some applications, the optical measurement devices include dedicated light sources (such as light emitting diodes, incandescent light sources, etc.) and/or optical elements for manipulating light collection and/or light emission (such as lenses, diffusers, filters, etc.).

A computer processor 28 typically receives and processes optical measurements that are performed by the optical measurement device. Further typically, the computer processor controls the acquisition of optical measurements that are performed by the one or more optical measurement devices. The computer processor communicates with a memory 30. A user (e.g., a laboratory technician, or an individual from whom the sample was drawn) sends instructions to the computer processor via a user interface 32. For some applications, the user interface includes a keyboard, a mouse, a joystick, a touchscreen device (such as a smartphone or a tablet computer), a touchpad, a trackball, a voice-command interface, and/or other types of user interfaces that are known in the art. Typically, the computer processor generates an output via an output device 34. Further typically, the output device includes a display, such as a monitor, and the output includes an output that is displayed on the display. For some applications, the processor generates an output on a different type of visual, text, graphics, tactile, audio, and/or video output device, e.g., speakers, headphones, a smartphone, or a tablet computer. For some applications, user interface 32 acts as both an input interface and an output interface, i.e., it acts as an input/output interface. For some applications, the processor generates an output on a computer-readable medium (e.g., a non-transitory computer-readable medium), such as a disk, or a portable USB drive, and/or generates an output on a printer.

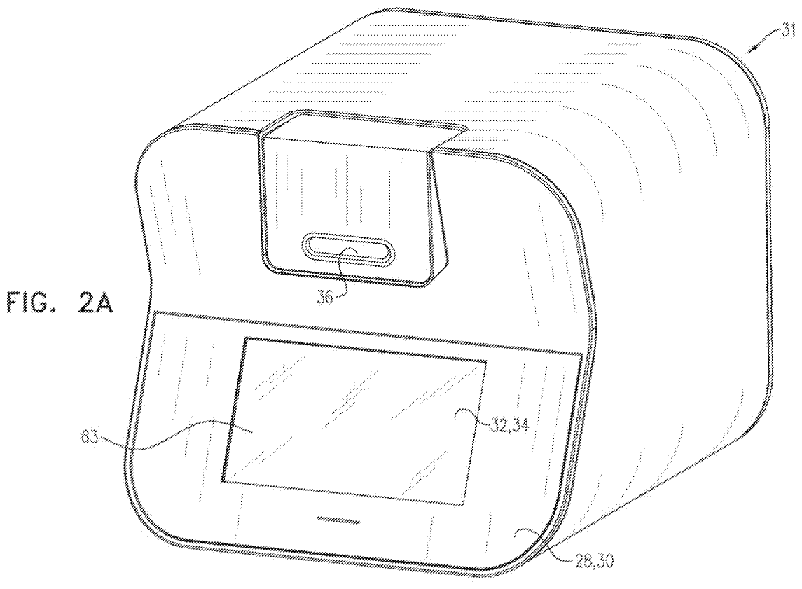

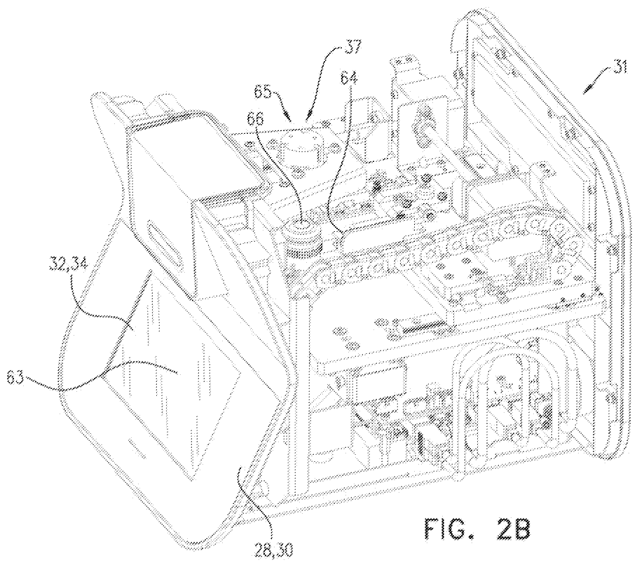

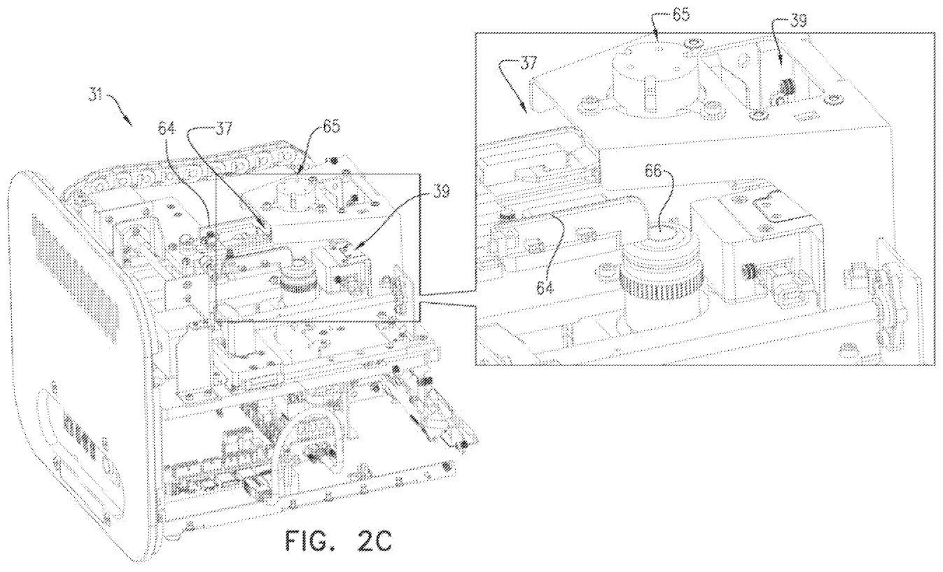

Reference is now made to FIGS. 2A, 2B, and 2C, which are schematic illustrations of an optical measurement unit 31, in accordance with some applications of the present invention. FIG. 2A shows an oblique view of the exterior of the fully assembled device, while FIGS. 2B and 2C shows respective oblique views of the device with the cover having been made transparent, such components within the device are visible. For some applications, one or more optical measurement devices 24 (and/or computer processor 28 and memory 30) is housed inside optical measurement unit 31. In order to perform the optical measurements upon the sample, sample carrier 22 is placed inside the optical measurement unit. For example, the optical measurement unit may define a slot 36, via which the sample carrier is inserted into the optical measurement unit. Typically, the optical measurement unit includes a stage 64, which is configured to support sample carrier 22 within the optical measurement unit. For some applications, a screen 63 on the cover of the optical measurement unit (e.g., a screen on the front cover of the optical measurement unit, as shown) functions as user interface 32 and/or output device 34.

Typically, the optical measurement unit includes microscope system 37 (shown in FIGS. 2B-C) configured to perform microscopic imaging of a portion of the sample. For some applications, the microscope system includes a set of light sources 65 (which typically include a set of brightfield light sources (e.g. light emitting diodes) that are configured to be used for brightfield imaging of the sample, a set of fluorescent light sources (e.g. light emitting diodes) that are configured to be used for fluorescent imaging of the sample), and a camera (e.g., a CCD camera, or a CMOS camera) configured to image the sample. Typically, the optical measurement unit also includes an optical-density-measurement unit 39 (shown in FIG. 2C) configured to perform optical density measurements (e.g., optical absorption measurements) on a second portion of the sample. For some applications, the optical-density-measurement unit includes a set of optical-density-measurement light sources (e.g., light emitting diodes) and light detectors, which are configured for performing optical density measurements on the sample. For some applications, each of the aforementioned sets of light sources (i.e., the set of brightfield light sources, the set of fluorescent light sources, and the set optical-density-measurement light sources) includes a plurality of light sources (e.g. a plurality of light emitting diodes), each of which is configured to emit light at a respective wavelength or at a respective band of wavelengths.

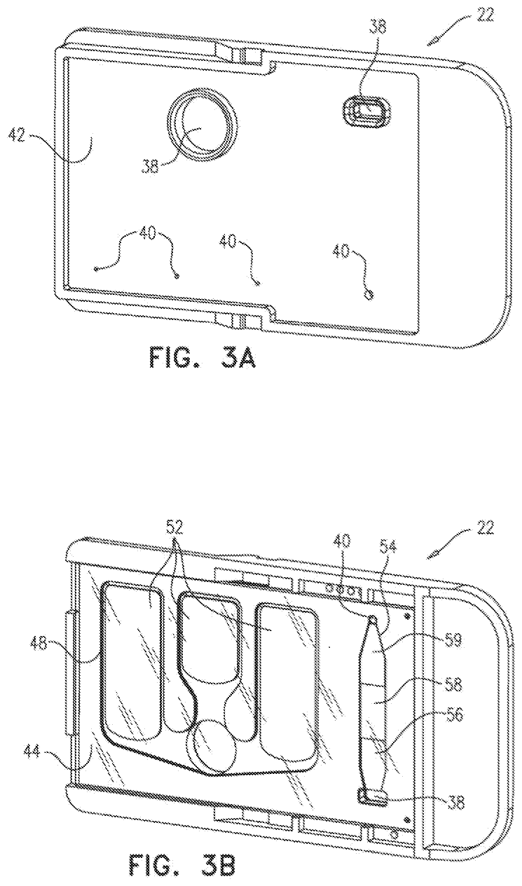

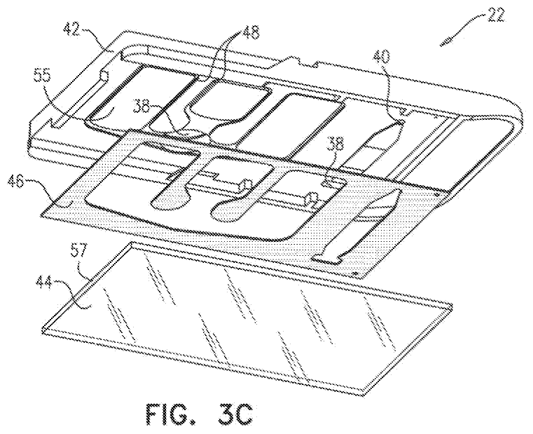

Reference is now made to FIGS. 3A and 3B, which are schematic illustrations of respective views of sample carrier 22, in accordance with some applications of the present invention. FIG. 3A shows a top view of the sample carrier (the top cover of the sample carrier being shown as being opaque in FIG. 3A, for illustrative purposes), and FIG. 3B shows a bottom view (in which the sample carrier has been rotated around its short edge with respect to the view shown in FIG. 3A). Typically, the sample carrier includes a first set 52 of one or more sample chambers, which are used for performing microscopic analysis upon the sample, and a second set 54 of sample chambers, which are used for performing optical density measurements upon the sample. Typically, the sample chambers of the sample carrier are filled with a bodily sample, such as blood via sample inlet holes 38. For some applications, the sample chambers define one or more outlet holes 40. The outlet holes are configured to facilitate filling of the sample chambers with the bodily sample, by allowing air that is present in the sample chambers to be released from the sample chambers. Typically, as shown, the outlet holes are located longitudinally opposite the inlet holes (with respect to a sample chamber of the sample carrier). For some applications, the outlet holes thus provide a more efficient mechanism of air escape than if the outlet holes were to be disposed closer to the inlet holes.

Reference is made to FIG. 3C, which shows an exploded view of sample carrier 22, in accordance with some applications of the present invention. For some applications, the sample carrier includes at least three components: a molded component 42, a glass layer 44 (e.g., glass sheet), and an adhesive layer 46 configured to adhere the glass layer to an underside of the molded component. The molded component is typically made of a polymer (e.g., a plastic) that is molded (e.g., via injection molding) to provide the sample chambers with a desired geometrical shape. For example, as shown, the molded component is typically molded to define inlet holes 38, outlet holes 40, and gutters 48 which surround the central portion of each of the sample chambers. The gutters typically facilitate filling of the sample chambers with the bodily sample, by allowing air to flow to the outlet holes, and/or by allowing the bodily sample to flow around the central portion of the sample chamber.

For some applications, a sample carrier as shown in FIGS. 3A-C is used when performing a complete blood count on a blood sample. For some such applications, the sample carrier is used with optical measurement unit 31 configured as generally shown and described with reference to FIGS. 2A-C. For some applications, a first portion of the blood sample is placed inside first set 52 of sample chambers (which are used for performing microscopic analysis upon the sample, e.g., using microscope system 37 (shown in FIGS. 2B-C)), and a second portion of the blood sample is placed inside second set 54 of sample chambers (which are used for performing optical density measurements upon the sample, e.g., using optical-density-measurement unit 39 (shown in FIG. 2C)). For some applications, first set 52 of sample chambers includes a plurality of sample chambers, while second set 54 of sample chambers includes only a single sample chamber, as shown. However, the scope of the present application, includes using any number of sample chambers (e.g., a single sample chamber or a plurality of sample chambers) within either the first set of sample chambers or within the second set of sample chambers, or any combination thereof. The first portion of the blood sample is typically diluted with respect to the second portion of the blood sample. For example, the diluent may contain pH buffers, stains, fluorescent stains, antibodies, sphering agents, lysing agents, etc. Typically, the second portion of the blood sample, which is placed inside second set 54 of sample chambers is a natural, undiluted blood sample. Alternatively or additionally, the second portion of the blood sample may be a sample that underwent some modification, including, for example, one or more of dilution (e.g., dilution in a controlled fashion), addition of a component or reagent, or fractionation.

For some applications, one or more staining substances are used to stain the first portion of the blood sample (which is placed inside first set 52 of sample chambers) before the sample is imaged microscopically. For example, the staining substance may be configured to stain DNA with preference over staining of other cellular components. Alternatively, the staining substance may be configured to stain all cellular nucleic acids with preference over staining of other cellular components. For example, the sample may be stained with Acridine Orange reagent, Hoechst reagent, and/or any other staining substance that is configured to preferentially stain DNA and/or RNA within the blood sample. Optionally, the staining substance is configured to stain all cellular nucleic acids but the staining of DNA and RNA are each more prominently visible under some lighting and filter conditions, as is known, for example, for Acridine Orange. Images of the sample may be acquired using imaging conditions that allow detection of cells (e.g., brightfield) and/or imaging conditions that allow visualization of stained bodies (e.g. appropriate fluorescent illumination). Typically, the first portion of the sample is stained with Acridine Orange and with a Hoechst reagent. For example, the first (diluted) portion of the blood sample may be prepared using techniques as described in U.S. Pat. No. 9,329,129 to Pollak, which is incorporated herein by reference, and which describes a method for preparation of blood samples for analysis that involves a dilution step, the dilution step facilitating the identification and/or counting of components within microscopic images of the sample. For some applications, the first portion of the sample is stained with one or more stains that cause platelets within the sample to be visible under brightfield imaging conditions and/or under fluorescent imaging conditions, e.g., as described hereinabove. For example, the first portion of the sample may be stained with methylene blue and/or Romanowsky stains.

Referring again to FIGS. 2B-C, typically, sample carrier 22 is supported within the optical measurement unit by stage 64. Further typically, the stage has a forked design, such that the sample carrier is supported by the stage around the edges of the sample carrier, but such that the stage does not interfere with the visibility of the sample chambers of the sample carrier by the optical measurement devices. For some applications, the sample carrier is held within the stage, such that molded component 42 of the sample carrier is disposed above the glass layer 44, and such that an objective lens 66 of a microscope unit of the optical measurement unit is disposed below the glass layer of the sample carrier. Typically, at least some light sources 65 that are used during microscopic measurements that are performed upon the sample (for example, light sources that are used during brightfield imaging) illuminate the sample carrier from above the molded component. Further typically, at least some additional light sources (not shown) illuminate the sample carrier from below the sample carrier (e.g., via the objective lens). For example, light sources that are used to excite the sample during fluorescent microscopy may illuminate the sample carrier from below the sample carrier (e.g., via the objective lens).

Typically, prior to being imaged microscopically, the first portion of blood (which is placed in first set 52 of sample chambers) is allowed to settle such as to form a monolayer of cells, e.g., using techniques as described in US 9,329,129 to Pollak, which is incorporated herein by reference. For some applications, the first portion of blood is a cell suspension and the chambers belonging to the first set 52 of chambers each define a cavity 55 that includes a base surface 57 (shown in FIG. 3C). Typically, the cells in the cell suspension are allowed to settle on the base surface of the sample chamber of the carrier to form a monolayer of cells on the base surface of the sample chamber. Subsequent to the cells having been left to settle on the base surface of the sample chamber (e.g., by having been left to settle for a predefined time interval), at least one microscopic image of at least a portion of the monolayer of cells is typically acquired. Typically, a plurality of images of the monolayer are acquired, each of the images corresponding to an imaging field that is located at a respective, different area within the imaging plane of the monolayer. Typically, an optimum depth level at which to focus the microscope in order to image the monolayer is determined, e.g., using techniques as described in U.S. Pat. No. 10,176,565 to Greenfield, which is incorporated herein by reference. For some applications, respective imaging fields have different optimum depth levels from each other.

It is noted that, in the context of the present application, the term monolayer is used to mean a layer of cells that have settled, such as to be disposed within a single focus level of the microscope (referred to herein as “the monolayer focus level”). Within the monolayer there may be some overlap of cells, such that within certain areas there are two or more overlapping layers of cells. For example, red blood cells may overlap with each other within the monolayer, and/or platelets may overlap with, or be disposed above, red blood cells within the monolayer.

For some applications, the microscopic analysis of the first portion of the blood sample is performed with respect to the monolayer of cells. Typically, the first portion of the blood sample is imaged under brightfield imaging, i.e., under illumination from one or more light sources (e.g., one or more light emitting diodes, which typically emit light at respective spectral bands). Further typically, the first portion of the blood sample is additionally imaged under fluorescent imaging. Typically, the fluorescent imaging is performed by exciting stained objects (i.e., objects that have absorbed the stain(s)) within the sample by directing light toward the sample at known excitation wavelengths (i.e., wavelengths at which it is known that stained objects emit fluorescent light if excited with light at those wavelengths), and detecting the fluorescent light. Typically, for the fluorescent imaging, a separate set of light sources (e.g., one or more light emitting diodes) is used to illuminate the sample at the known excitation wavelengths.

As described with reference to US 2019/0302099 to Pollak, which is incorporated herein by reference, for some applications, sample chambers belonging to set 52 (which is used for microscopy measurements) have different heights from each other, in order to facilitate different measurands being measured using microscope images of respective sample chambers, and/or different sample chambers being used for microscopic analysis of respective sample types. For example, if a blood sample, and/or a monolayer formed by the sample, has a relatively low density of red blood cells, then measurements may be performed within a sample chamber of the sample carrier having a greater height (i.e., a sample chamber of the sample carrier having a greater height relative to a different sample chamber having a relatively lower height), such that there is a sufficient density of cells, and/or such that there is a sufficient density of cells within the monolayer formed by the sample, to provide statistically reliable data. Such measurements may include, for example red blood cell density measurements, measurements of other cellular attributes, (such as counts of abnormal red blood cells, red blood cells that include intracellular bodies (e.g., pathogens, Howell-Jolly bodies), etc.), and/or hemoglobin concentration. Conversely, if a blood sample, and/or a monolayer formed by the sample, has a relatively high density of red blood cells, then such measurements may be performed upon a sample chamber of the sample carrier having a relatively low height, for example, such that there is a sufficient sparsity of cells, and/or such that there is a sufficient sparsity of cells within the monolayer of cells formed by the sample, that the cells can be identified within microscopic images. For some applications, such methods are performed even without the variation in height between the sample chambers belonging to set 52 being precisely known.

For some applications, based upon the measurand that is being measured, the sample chamber within the sample carrier upon which to perform optical measurements is selected. For example, a sample chamber of the sample carrier having a greater height may be used to perform a white blood cell count (e.g., to reduce statistical errors which may result from a low count in a shallower region), white blood cell differentiation, and/or to detect more rare forms of white blood cells. Conversely, in order to determine mean corpuscular hemoglobin (MCH), mean corpuscular volume (MCV), red blood cell distribution width (RDW), red blood cell morphologic features, and/or red blood cell abnormalities, microscopic images may be obtained from a sample chamber of the sample carrier having a relatively low height, since in such sample chambers the cells are relatively sparsely distributed across the area of the region, and/or form a monolayer in which the cells are relatively sparsely distributed. Similarly, in order to count platelets, classify platelets, and/or extract any other attributes (such as volume) of platelets, microscopic images may be obtained from a sample chamber of the sample carrier having a relatively low height, since within such sample chambers there are fewer red blood cells which overlap (fully or partially) with the platelets in microscopic images, and/or in a monolayer.

In accordance with the above-described examples, it is preferable to use a sample chamber of the sample carrier having a lower height for performing optical measurements for measuring some measurands within a sample (such as a blood sample), whereas it is preferable to use a sample chamber of the sample carrier having a greater height for performing optical measurements for measuring other measurands within such a sample. Therefore, for some applications, a first measurand within a sample is measured, by performing a first optical measurement upon (e.g., by acquiring microscopic images of) a portion of the sample that is disposed within a first sample chamber belonging to set 52 of the sample carrier, and a second measurand of the same sample is measured, by performing a second optical measurement upon (e.g., by acquiring microscopic images of) a portion of the sample that is disposed within a second sample chamber of set 52 of the sample carrier. For some applications, the first and second measurands are normalized with respect to each other, for example, using techniques as described in US 2019/0145963 to Zait, which is incorporated herein by reference.

Typically, in order to perform optical density measurements upon the sample, it is desirable to know the optical path length, the volume, and/or the thickness of the portion of the sample upon which the optical measurements were performed, as precisely as possible. Typically, an optical density measurement is performed on the second portion of the sample (which is typically placed into second set 54 of sample chambers in an undiluted form). For example, the concentration and/or density of a component may be measured by performing optical absorption, transmittance, fluorescence, and/or luminescence measurements upon the sample.

Referring again to FIG. 3B, for some applications, sample chambers belonging to set 54 (which is used for optical density measurements), define at least a first region 56 (which is typically deeper) and a second region 58 (which is typically shallower), the height of the sample chambers varying between the first and second regions in a predefined manner, e.g., as described in US 2019/0302099 to Pollak, which is incorporated herein by reference. The heights of first region 56 and second region 58 of the sample chamber are defined by a lower surface that is defined by the glass layer and by an upper surface that is defined by the molded component. The upper surface at the second region is stepped with respect to the upper surface at the first region. The step between the upper surface at the first and second regions, provides a predefined height difference Ah between the regions, such that even if the absolute height of the regions is not known to a sufficient degree of accuracy (for example, due to tolerances in the manufacturing process), the height difference Ah is known to a sufficient degree of accuracy to determine a parameter of the sample, using the techniques described herein, and as described in US 2019/0302099 to Pollak, which is incorporated herein by reference. For some applications, the height of the sample chamber varies from the first region 56 to the second region 58, and the height then varies again from the second region to a third region 59, such that, along the sample chamber, first region 56 defines a maximum height region, second region 58 defines a medium height region, and third region 59 defines a minimum height region. For some applications, additional variations in height occur along the length of the sample chamber, and/or the height varies gradually along the length of the sample chamber.

As described hereinabove, while the sample is disposed in the sample carrier, optical measurements are performed upon the sample using one or more optical measurement devices 24. Typically, the sample is viewed by the optical measurement devices via the glass layer, glass being transparent at least to wavelengths that are typically used by the optical measurement device. Typically, the sample carrier is inserted into optical measurement unit 31, which houses the optical measurement device while the optical measurements are performed. Typically, the optical measurement unit houses the sample carrier such that the molded layer is disposed above the glass layer, and such that the optical measurement unit is disposed below the glass layer of the sample carrier and is able to perform optical measurements upon the sample via the glass layer. The sample carrier is formed by adhering the glass layer to the molded component. For example, the glass layer and the molded component may be bonded to each other during manufacture or assembly (e.g. using thermal bonding, solvent-assisted bonding, ultrasonic welding, laser welding, heat staking, adhesive, mechanical clamping and/or additional substrates). For some applications, the glass layer and the molded component are bonded to each other during manufacture or assembly using adhesive layer 46.

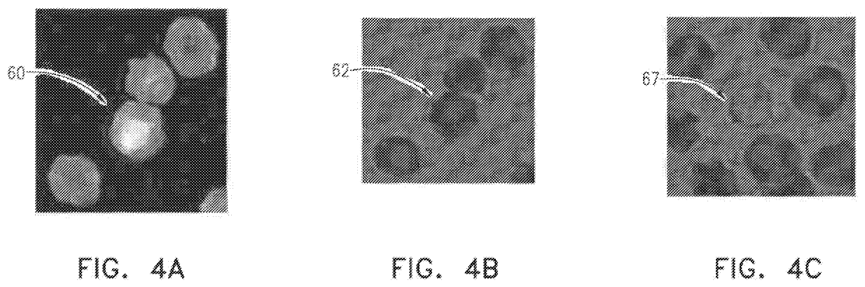

Reference is now made to FIGS. 4A-C, which are microscopic images that were acquired in accordance with some applications of the present invention. As described hereinabove in the Background section, mammalian red blood cells are the body's carriers of oxygen. During their maturation process red blood cells undergo de-nucleation, i.e., complete removal of the nucleus from the cell. Normally, nucleated red blood cells (NRBCs) are not found in peripheral blood of adult patients. However, in some conditions (such as newborns, oncology patient, anemia patients, etc.) NRBCs are found in peripheral blood. As NRBCs are similar in size and nucleus content to some leukocytes (and, particularly, lymphocytes), it is typically difficult to distinguish between NRBCs and leukocytes. For example, FIG. 4A shows a combined image that includes a fluorescent microscopic image overlaid upon a brightfield microscopic image. The brightfield image was acquired under violet illumination conditions, and the microscope was off-focus with respect to the monolayer of cells within the sample when the brightfield image was acquired. The sample was stained with a Hoechst reagent, which has an affinity for DNA, and the Hoechst reagent had been excited prior to acquisition of the fluorescent image. (As described hereinabove, typically additional brightfield and/or fluorescent images of the sample are acquired. For example, it is typically the case that the sample is stained with Acridine Orange and a fluorescent image in which the Acridine Orange is excited is acquired.) An entity 60 is visible in the image, and the entity has a size indicating that it could be either an NRBC or a leukocyte. Moreover, the central portion of the entity is fluorescing, indicating the presence of a nucleus, which would be expected both if the entity is an NRBC or if it is a leukocyte.

As described hereinabove, in some applications of the present invention, a complete blood count is performed upon a blood sample. In the context of a complete blood count, it is typically important to differentiate between NRBCs and leukocytes, in order to avoid overcounting leukocytes (particularly in patients having a low leukocyte count) and in order to detect the presence of NRBCs (which may be indicative of an underlying condition).

In accordance with some applications of the present invention, in order to distinguish between a leukocyte (e.g., a lymphocyte) and an NRBC (e.g., in a situation in which an NRBC/leukocyte candidate (i.e., a candidate which may be either an NRBC or a leukocyte) was detected), a microscope image is acquired while the sample is illuminated with light having a wavelength at which hemoglobin has a high level of absorption. Typically, violet light, e.g., light having a wavelength within the range of more than 400 nm and/or less than 450 nm (e.g., 400-450 nm) is used. Within this wavelength range, the absorption of hemoglobin is relatively high, compared to other wavelengths within the visible spectrum. Typically, NRBCs have a high hemoglobin content (of the order of 30 picogram per cell), while leukocytes contain no hemoglobin. Therefore, within the images that are acquired under the violet light illumination, NRBCs typically absorb light, whereas leukocytes do not. For some applications, light having a wavelength of more than 500 nm and/or less than 600 nm (e.g., 500-600 nm) is used. Within this wavelength range, the absorption of carbaminohemoglobin is relatively high, compared to other wavelengths within the visible spectrum. Therefore, within the images that are acquired under illumination within the aforementioned range of wavelengths, NRBCs typically absorb light, whereas leukocytes do not.

Referring now to FIGS. 4B and 4C, FIG. 4B shows an NRBC 62 within an image that was acquired under violet light illumination, while FIG. 4C shows a leukocyte 67 within an image that was acquired under violet light illumination. As shown, the whole of the NRBC appears dark, due to absorption of light by hemoglobin within the NRBC, whereas the center of the leukocyte does not appear dark, since there is no hemoglobin present within the leukocyte. Therefore, typically, at least partially based upon the intensity of the entity within an image that is acquired under violet light illumination, then the entity is classified as being either an NRBC or a leukocyte. For some applications, an intensity threshold is applied to the image acquired under violet lighting conditions (and/or to given regions or pixels thereof), and the entity is classified as either being either an NRBC or a leukocyte based upon whether or not the intensity of the entity passes the threshold.

Typically, entities that are NRBC/leukocyte candidates (i.e., candidates which may be either an NRBC or a leukocyte) are first identified based upon brightfield images that are acquired at wavelengths other than the violet wavelengths, and/or based upon fluorescent images. In response to identifying such candidates, an image that is acquired under violet illumination conditions is analyzed (e.g., in the manner described hereinabove), in order to distinguish between NRBCs and leukocytes. For some applications, an image of a given imaging field is only acquired under violet illumination conditions, if one or more (e.g., a given minimum number) of NRBC/leukocyte candidates are identified within the imaging field. That is to say that the computer processor drives the microscope to acquire the image under violet illumination only in response to detecting a need to do so, by virtue of having identified an NRBC/leukocyte candidates (and/or more than a given number or concentration of NRBC/leukocyte candidates) within the imaging field.

For some applications, additional features are used to distinguish between NRBCs and leukocytes. For example, such additional features may include cell size, nucleus size, fluorescence intensity, intensity of the cytoplasm, area of the cytoplasm, ellipticity of the cell, ellipticity of the nucleus, roundness of the nucleus, and/or any combination of the aforementioned features. For some applications, one or more images of NRBC/leukocyte candidates are acquired under different brightfield illumination conditions, e.g., red light and/or green light, and the classification of the candidate is verified by analyzing the one or more additional images. For some applications, the image acquired under violet lighting conditions and/or the one or more additional images are off-focus brightfield images. For some applications, machine-learning classifiers (e.g., a convolutional neural network classifier, a decision tree classifier, a regression analysis classifier, a Bayesian network classifier, and/or a support network vector classifier), are applied to one or more of the above-described features of an NRBC/leukocyte candidate, in order to classify the NRBC/leukocyte candidate as either an NRBC or a leukocyte. Alternatively or additionally, neural networks classifiers may be applied to raw images (such images typically including the image acquired under violet illumination conditions) in order to classify an NRBC/leukocyte candidate as either an NRBC or a leukocyte.

As noted hereinabove, typically NRBCs are absent from the blood of a healthy adult, and the presence of NRBCs is indicative of an underlying clinical condition. The presence of one or more NRBCs in the subject's blood may be indicative of an increased likelihood of additional entities within the blood sample being NRBCs as opposed to leukocytes (which are always present in blood). For some applications, in response to even a single NRBC being detected (and/or in response to a given number or a given concentration of NRBCs being detected), one or more thresholds that are used for identifying an entity as an NRBC are adjusted, such that the sensitivity of the computer processor to NRBCs is increased. Typically, in response to identifying one or more NRBCs (e.g., in response to detecting more than a given number and/or more than a given concentration of NRBCs), an output is generated to the user flagging that NRBCs have been identified, and/or indicating the concentration or relative concentration of NRBCs that have been identified.

For some applications, in response to detecting more than a given number and/or more than a given concentration of NRBCs, the computer processor adjusts thresholds that are used for detecting other entities, and/or generates an output indicating that the count of other entities may be erroneous. For some applications, in response to detecting a relatively high NRBC count in combination with a relatively low leukocyte count, the computer processor interprets this as indicating that some NRBC/leukocyte candidates were wrongly classified. In response thereto, the computer processor typically re-analyzes at least some of the candidates, and/or generates an output indicting that there may be in an error in the count of NRBCs and/or the count of the leukocytes. For some applications, the computer processor detects that only a given type (or given types) of leukocytes have a low concentration, indicating that only this type (or types) of leukocytes have been incorrectly distinguished from NRBCs. In response thereto, the computer processor typically generates an output indicting that there may be in an error in the count of the given type (or types) of leukocytes.

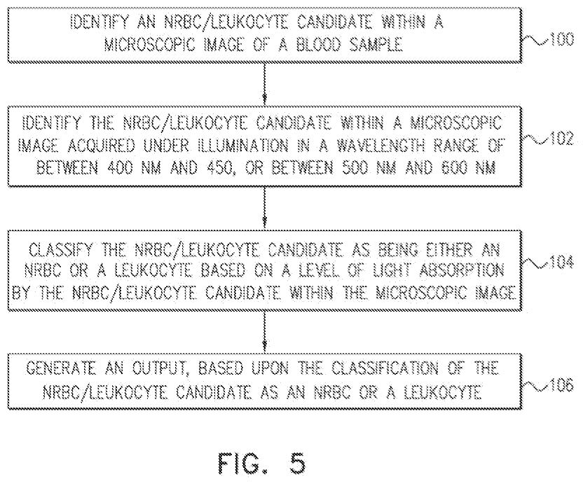

Reference is now made to FIG. 5, which is a flowchart showing steps of a method that is performed with respect to NRBC/leukocyte candidates identified within one or more microscopic images of a blood sample, in accordance with some applications of the present invention. As described hereinabove with reference to FIGS. 4A-C, and shown in the flowchart of FIG. 5, an NRBC/leukocyte candidate is identified within one or more microscopic images of the blood sample (step 100), and then the NRBC/leukocyte candidate is identified within a microscopic image acquired under illumination in a wavelength range of between 400 nm and 450, or under illumination by light in a wavelength range of 500 nm and 600 nm (step 102). The NRBC/leukocyte candidate is then classified as being either an NRBC or a leukocyte based on a level of light absorption by the NRBC/leukocyte candidate within the microscopic image (step 104), and an output is generated based upon the classification of the NRBC/leukocyte candidate as an NRBC or a leukocyte (step 106).

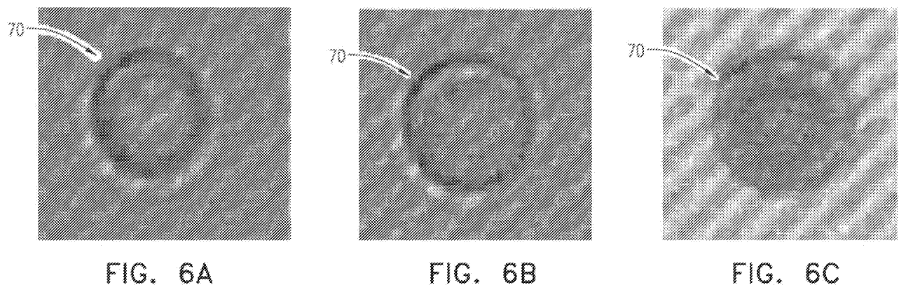

Reference is now made to FIGS. 6A, 6B, and 6C, which are microscopic images of a red blood cell 70 that are acquired under, respectively, red, green, and violet illumination condition, in accordance with some applications of the present invention. Typically, the absorption of hemoglobin variants in the violet light range (e.g., at more than 400 nm and/or less than 450 nm (e.g., between 400 nm and 450 nm)) is between 1 and 3 orders of magnitude larger than the absorption in any of the other wavelengths in the visible spectrum. As may be observed in FIGS. 6A-C, the contrast between the red blood cell and the background in FIG. 6C (which was acquired under violet illumination conditions) is much greater than that of FIG. 6A (acquired under red illumination) and FIG. 6B (acquired under green illumination).

Therefore, for some applications, in order to determine a hemoglobin-related property of a blood sample, the blood sample is imaged under violet illumination conditions. For example, for the hemoglobin content of a single red blood cell may be determined by measuring absorption of the violet light. For some applications, absorption measurements that are performed under violet lighting conditions are performed in combination with additional absorption measurements that are performed under different lighting conditions (e.g., red or green lighting conditions). Typically, this is applied to a plurality of cells, and statistical hemoglobin-related properties of the sample are determined, such as, mean corpuscular hemoglobin (MCH), hemoglobin distribution width. For some applications, cell volume data are additionally determined. For example, the volumes of individual cells, and/or the mean cell volume of red blood cells within the sample may be determined. Based upon the mean corpuscular hemoglobin and the cell volume data, the computer processor determines the mean corpuscular hemoglobin concentration for the sample. For some applications, light having a wavelength of more than 500 nm and/or less than 600 nm (e.g., 500-600 nm) is used. Within this wavelength range, the absorption of carbaminohemoglobin is relatively high, compared to other wavelengths within the visible spectrum.

For some applications, the red blood cell population is classified into sub-populations, such as reticulocytes, NRBCs, and/or cells having certain morphological features (e.g., sickle cells, oval cells, target cells, echinocytes, etc.). For some applications, the above-described statistical hemoglobin-related properties of the sample are determined for one of more of the red blood cell sub-populations. For example, the computer processor may determine mean reticulocyte hemoglobin, or mean sickle-cell hemoglobin, mean echinocyte hemoglobin concentration, etc.

Reference is now made to FIG. 7, which is a flowchart showing steps of a method that is performed with respect to red blood cells identified within one or more microscopic images of a blood sample, in accordance with some applications of the present invention. As described hereinabove with reference to FIGS. 6A-C, and shown in the flowchart in FIG. 7, a microscopic image of a blood sample is acquired, under illumination by light in a wavelength range of 400 nm and 450 nm or under illumination by light in a wavelength range of 500 nm and 600 nm (step 110), and red blood cells are identified in the microscopic image (step 112). Hemoglobin-related properties of the blood sample are determined, based on the identified red blood cells (step 114) and an output is generated based on the determined hemoglobin-related properties (step 116).

As described hereinabove, for some applications, the cells in the cell suspension are allowed to settle on the base surface of the sample chamber of carrier 22, to form a monolayer of cells on the base surface of the sample chamber. Subsequent to the cells having been left to settle on the base surface of the sample chamber (e.g., by having been left to settle for a predefined time interval), at least one microscopic image of at least a portion of the monolayer of cells is typically acquired. As noted hereinabove, in the context of the present application, the term monolayer is used to mean a layer of cells that have settled, such as to be disposed within a single focus level of the microscope (referred to herein as “the monolayer focus level”). For some applications, in addition to acquiring images with the microscope focal plane set to approximately coincide with the monolayer focus level (such images being referred to herein as “on-focus” images), the microscope acquires images with the microscope focal plane set to be offset along the optical axis with respect to the monolayer focal level (such images being referred to herein as “off-focus” images). Typically, such off-focus microscopic images are acquired with the focal plane of the microscope set closer to the objective lens of the microscope than the monolayer focus level, although the scope of the present invention includes acquiring off-focus images with the focal plane of the microscope set farther from the objective lens of the microscope than the monolayer focus level. Typically, the off-focus microscopic images are acquired with the focal plane of the microscope set at a predetermined offset with respect to the monolayer focus level. For some applications, the off-focus microscopic images are acquired with the focal plane of the microscope set at an offset with respect to the monolayer focus level of more than 20 microns and/or less than 100 microns, e.g., 20-100 microns. Alternatively or additionally, the off-focus microscopic images are acquired with the focal plane of the microscope set at an offset with respect to the monolayer focus level of more than one times the depth of focus the microscope, and/or less than five times the depth of focus of the microscope, e.g., between one five depths of focus of the microscope.

The inventors of the present application have found that such off-focus microscopic images can generate important data regarding a sample. In particular, off-focus images are typically used to identify the outlines of cells, and/or to identify certain entities within a sample, such as leukocytes, leukocyte types (e.g., lymphocytes, granulocytes, monocytes, neutrophils, banded neutrophils, eosinophils, basophils, macrophages, and/or blast cells), red blood cells, red blood cell types (e.g., mature red blood cell, NRBC, echinocyte, sickle cell, tear-drop cell), and/or platelets. For some applications, off-focus images are used to enhance the visibility of such entities with respect to other entities, such that they may be identified with a greater degree of certainty. Alternatively or additionally, off-focus images are used to make such entities more easily distinguishable from other entities to which they might otherwise be confused. For some applications, off-focus images are used to characterize features of cells, such as hemoglobin content of red blood cells, other components of red blood cells, and/or maturity of a cell (such as a neutrophil).

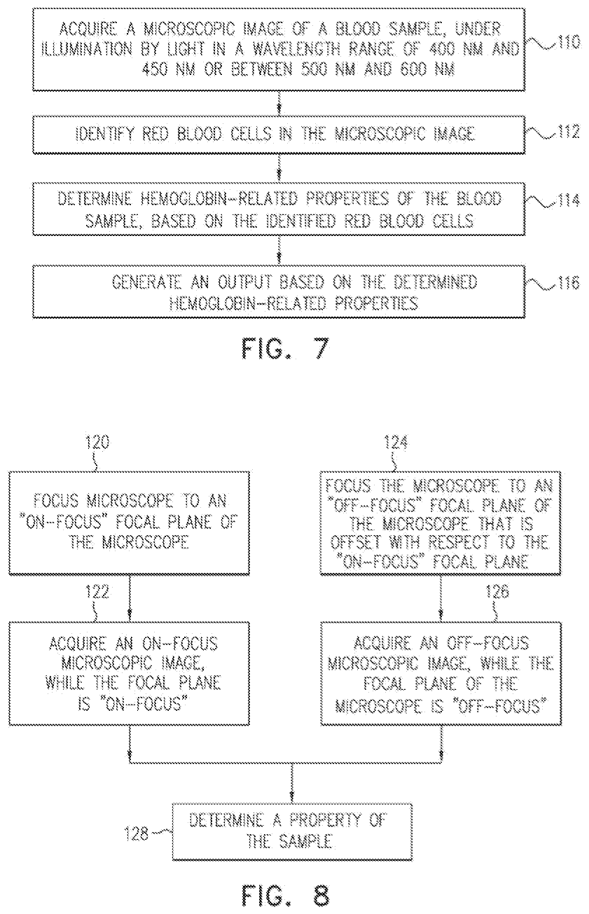

Reference is first made to FIG. 8, which is a flowchart showing steps of a method for use with a bodily sample that contains cells, in accordance with some applications of the present invention. As described hereinabove, and shown in the flowchart in FIG. 8, a microscope is focused to an “on-focus” focal plane of the microscope in which a focal plane of the microscope at least approximately coincides with a level at which at least some cells belonging to the sample are at least partially disposed (step 120). An on-focus microscopic image is then acquired, while the focal plane is “on-focus” such that the focal plane of the microscope approximately coincides with the level at which at least some cells belonging to the sample are at least partially disposed (step 122). Additionally, the microscope is focused to an “off-focus” focal plane of the microscope in which the focal plane of the microscope is offset with respect to the level at which at least some cells belonging to the sample are at least partially disposed (i.e. offset with respect to the “on-focus” focal plane) (step 124). An off-focus microscopic image is then acquired, while the focal plane of the microscope is offset with respect to the level at which at least some cells belonging to the sample are at least partially disposed (step 126). A property of at least a portion of the sample is then determined, at least partially based upon the on-focus and off-focus image (step 128).

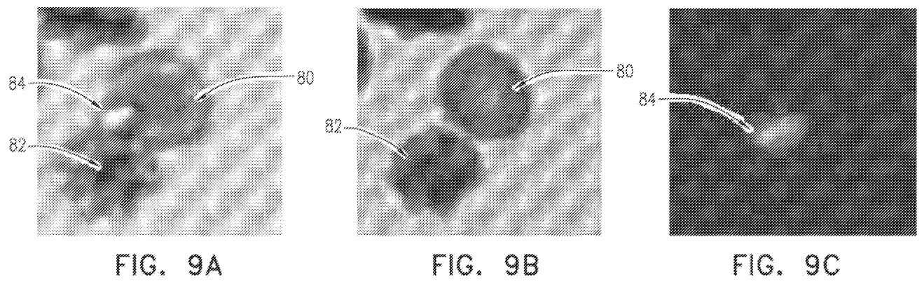

It is noted that, typically, off-focus images are acquired not only at wavelengths at which light absorption by hemoglobin is low (e.g., red light, such as light in the wavelength range of approximately 620-640 nm), but also at wavelengths at which there is mild absorption of light by hemoglobin (e.g., green light, such as light in the wavelength range of approximately 505-535 nm, or 520-530 nm), or even at wavelengths at which there is heavy absorption of light by hemoglobin (e.g., violet light, such as light in the wavelength range of more than 400 nm and/or less than 450 nm (e.g., 400-450 nm)). Some examples of the use of such images are described hereinbelow, with reference to FIGS. 9A-12C.

Reference is now made to FIGS. 9A and 9B, which are examples of brightfield microscopic images of a monolayer of cells of a blood sample that were acquired using violet illumination with the microscope focal plane set, respectively, to coincide with the monolayer of cells (FIG. 9A), and with the microscope focal plane set to be off-focus with respect to the monolayer of cells (FIG. 9B), in accordance with some applications of the present invention. In the on-focus image (FIG. 9A), a red blood cell 80 and an echinocyte 82 are visible. In addition, a bright area 84 may be observed. The bright area is a platelet. However, based upon the raw on-focus image, it can be difficult to identify the platelet, and it can be difficult to distinguish a platelet from other entities (such as intraerythrocytic parasites or leukocytes). As may also be observed, in the off-focus image (FIG. 9B), the bright area is less visible. For some applications, the computer processor performs a normalization based upon the on-focus and off-focus images (e.g., by subtracting one of the images from the other, or dividing one of the images by the other). Typically, based upon the normalization, the bright area is more clearly visible and the computer processor is able to identify the bright area as a platelet to a greater degree of certainty than it would be able to based solely upon the raw on-focus image. (It is noted that, for some applications, the two images are not in fact normalized with respect to each other, but rather processing steps are performed by the computer processor that are the equivalent of normalizing the images or portions thereof with respect to each other.) Reference is now made to FIG. 9C, which is a fluorescent microscopic image of the same portion of the sample as shown in FIGS. 9A and 9B, after staining the sample with Acridine Orange and with a Hoechst reagent and exciting the sample with UV light, such that the platelet fluoresces, in accordance with some applications of the present invention. In this image, the platelet is clearly visible and is distinguishable from surrounding entities. As illustrated by FIGS. 9A and 9B, performing a normalization based upon the on-focus and off-focus images is an alternative or additional method of enhancing the visibility of a platelet.

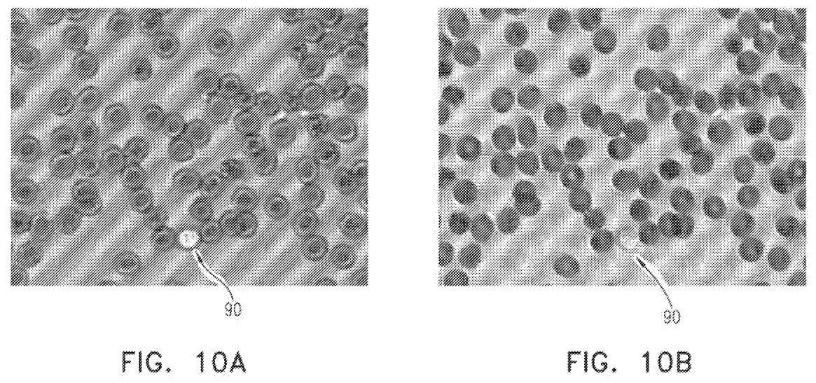

Reference is now made to FIGS. 10A and 10B, which are examples of brightfield microscopic images of a monolayer of cells of a blood sample that were acquired using violet illumination with the microscope focal plane set, respectively, to coincide with the monolayer of cells (FIG. 10A), and with the microscope focal plane set to be off-focus with respect to the monolayer of cells (FIG. 10B), in accordance with some applications of the present invention. In the on-focus image (FIG. 10A), a bright entity 90 having a circular shape is visible. The entity is a leukocyte. However, based upon the raw on-focus image, it can be difficult to identify the white blood cell, and it can be difficult to distinguish a leukocyte from other entities (such as platelets or platelet clusters). As may also be observed, in the off-focus image (FIG. 10B), the bright entity is less visible. Moreover, it can be difficult to classify the leukocyte as a specific type of leukocyte (e.g., lymphocyte, granulocyte, monocyte, neutrophil, banded neutrophil, eosinophil, basophil, macrophage, and/or blast cells). For some applications, the computer processor performs a normalization based upon the on-focus and off-focus images (e.g., by subtracting one of the images from the other, or dividing one of the images by the other). Typically, based upon the normalization, the bright entity is more clearly visible and the computer processor is able to identify the bright entity as a leukocyte, and/or to classify the leukocyte as a specific type of leukocyte, to a greater degree of certainty than it would be able to based upon the raw on-focus image. (It is noted that, for some applications, the two images are not in fact normalized with respect to each other, but rather processing steps are performed by the computer processor that are the equivalent of normalizing the images or portions thereof with respect to each other.)

In accordance with the above description of FIGS. 9A-B and 10A-B, for some applications, the computer processor identifies one or more entities within a sample (e.g., by distinguishing the one or more entities from other entities) based at least partially on an off-focus image of a monolayer of cells within the sample. For some such applications, a normalization is performed based upon an on-focus image and an off-focus image, and the computer processor identifies one or more entities within the sample (e.g., by distinguishing the one or more entities from other entities) based upon the normalization. Although the examples shown in FIGS. 9A-B and 10A-B relate to platelets and leukocytes, for some applications, generally similar techniques are used to identify other entities, such as anomalous white blood cells, circulating tumor cells, red blood cells, reticulocytes, Howell-Jolly bodies, sickle cells, tear-drop cells, etc.

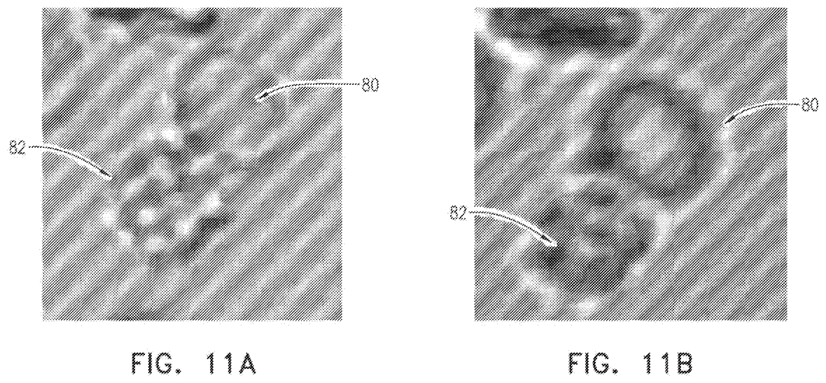

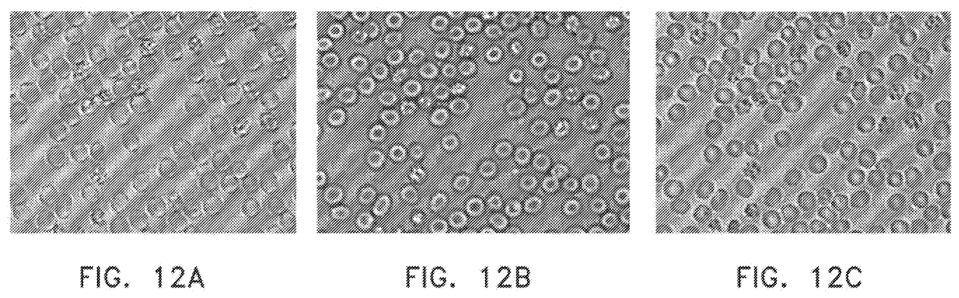

Referring again to FIGS. 9A-B and FIGS. 10A-B, it may additionally be observed that, in the off-focus images, the outlines of cells (and particularly, red blood cells, echinocytes, and other red blood cell types) are more clearly visible than in the on-focus image. For some applications, the outlines are more clearly visible in the off-focus images, due to some refraction and/or diffraction effects being reduced relative to on-focus images. Some additional examples of this are shown in FIGS. 11A-12C.

Referring now to FIGS. 11A-B, these figures are examples of brightfield microscopic images of a monolayer of cells of a blood sample that were acquired using green illumination with the microscope focal plane set, respectively, to coincide with the monolayer of cells (FIG. 11A), and with the microscope focal plane set to be off-focus with respect to the monolayer of cells (FIG. 11B), in accordance with some applications of the present invention. As may be observed, it is also the case that in the off-focus image acquired under green illumination, the outlines of cells (and particularly, red blood cells, echinocytes, and other red blood cell types) are more clearly visible than in the on-focus image.

Referring now to FIGS. 12A-C, these figures are examples of brightfield microscopic images of a monolayer of cells of a blood sample that were acquired using green illumination with the microscope focal plane set, respectively, to coincide with the monolayer of cells (FIG. 12A), and with the microscope focal plane set to be off-focus with respect to the monolayer of cells (FIGS. 12B and 12C), in accordance with some applications of the present invention. FIG. 12B was acquired with the focal plane of the microscope set closer to the objective lens of the microscope than the monolayer of cells, while FIG. 12C was acquired with the focal plane of the microscope set farther from the objective lens of the microscope than the monolayer of cells. As may be observed, it is the case that in off-focus images that are acquired with the focal plane of the microscope set closer to the objective lens of the microscope than the monolayer of cells, or farther from the objective lens of the microscope than the monolayer of cells, the outlines of cells (and particularly, red blood cells, echinocytes, and other red blood cell types) are more clearly visible than in the on-focus image.

In accordance with the above description of FIGS. 9A-B, 10A-B, and 11A-12C, for some applications of the present invention, the computer processor determines the outlines of one or more entities in a blood sample based upon an off-focus image. For some applications, the computer processor determines additional parameters of the one or more entities based upon the determined outlines. For example, the computer processor may determine a cell volume, cell area, mean cell volume, and/or mean cell area, based upon the determined outlines.

For some applications, the computer processor determines one or more parameters of the sample (and/or of entities disposed therein) using a machine-learning classifier, e.g., a neural network (such as, a convolutional neural network). For some applications, parameters that are derived from one or more off-focus images are used an inputs to the machine-learning classifier, and parameters of the sample (and/or of entities disposed therein) are determined in response thereto. For example, parameters that are derived from an off-focus image may be used as inputs into a classifier that estimates cell hemoglobin, cell volume, mean cell hemoglobin, mean cell volume, and/or additional parameters.

It is often the case that, even after a blood sample has been left to settle such as to form a monolayer using the techniques described herein, not all of the platelets within the blood sample settle within the monolayer, and some cells continue to be suspended within the cell solution. For some applications, in order to accurately estimate the number of platelets in the sample, platelets that are suspended within the cell solution are identified, in addition to identifying platelets within the monolayer focus level. Typically, such platelets are identified by focusing the microscope at additional depth levels to the depth level(s) to which the microscope is focused in order to image the monolayer of cells, and acquiring images at the additional depth levels. Typically, the platelets within the images that are acquired at the additional depth levels are identified and counted, and, based upon the count of platelets within those images, a total count of the platelets that are suspended within the cell solution is estimated.

For some applications, in addition to acquiring on-focus images at each of the additional depth levels, off-focus images of the additional depth levels are acquired (i.e., images that are offset along the optical axis with respect to the focal planes of the additional depth levels). Typically, the off-focus microscopic images are acquired with the focal plane of the microscope set at a predetermined offset with respect to the additional depth level. For some applications, the off-focus microscopic images are acquired with the focal plane of the microscope set at an offset with respect to the additional depth level of more than 20 microns and/or less than 100 microns, e.g., 20-100 microns. Alternatively or additionally, the off-focus microscopic images are acquired with the focal plane of the microscope set at an offset with respect to the additional depth level of more than one times the depth of focus the microscope, and/or less than five times the depth of focus of the microscope, e.g., between one five depths of focus of the microscope. For some such applications, platelets are identified at the additional depth levels at least partially based upon the off-focus images of the additional depth levels, e.g., in accordance with the techniques described hereinabove.

In accordance with the above description, it is typically the case that there are certain effects that are to be expected when comparing on-focus images of a given region of a monolayer to off-focus images of that same region. For some applications, in order to verify that an on-focus image of a given region of a monolayer is at the optimum focus with respect to the monolayer, an off-focus image of the region is acquired (typically with the focal plane of the microscope set at a predetermined offset with respect to that of the on-focus image). The off-focus image and the on-focus image are then analyzed, and at least partially based upon the analysis, the computer processor determines whether the on-focus image is truly at the optimum focus with respect to the monolayer. For example, in response to detecting that outlines of cells are no more clearly visible in the off-focus image than in the on-focus image, the computer processor may determine that the on-focus image is not at the optimum focus with respect to the monolayer. In response thereto, the computer processor may refocus the microscope before acquiring a further on-focus image.

For some applications, the sample as described herein is a sample that includes blood or components thereof (e.g., a diluted or non-diluted whole blood sample, a sample including predominantly red blood cells, or a diluted sample including predominantly red blood cells), and parameters are determined relating to components in the blood such as platelets, white blood cells, anomalous white blood cells, circulating tumor cells, red blood cells, reticulocytes, Howell-Jolly bodies, sickle cells, tear-drop cells, etc.

For some applications, the apparatus and methods described herein are applied to a biological sample, other than blood such as, saliva, semen, sweat, sputum, vaginal fluid, stool, breast milk, bronchoalveolar lavage, gastric lavage, tears and/or nasal discharge, mutatis mutandis. The biological sample may be from any living creature, and is typically from warm blooded animals. For some applications, the biological sample is a sample from a mammal, e.g., from a human body. For some applications, the sample is taken from any domestic animal, zoo animals and farm animals, including but not limited to dogs, cats, horses, cows and sheep. Alternatively or additionally, the biological sample is taken from animals that act as disease vectors including deer or rats.

For some applications, the apparatus and methods described herein are applied to a non-bodily sample. For some applications, the sample is an environmental sample, such as, a water (e.g. groundwater) sample, surface swab, soil sample, air sample, or any combination thereof, mutatis mutandis. In some embodiments, the sample is a food sample, such as, a meat sample, dairy sample, water sample, wash-liquid sample, beverage sample, and/or any combination thereof.

Applications of the invention described herein can take the form of a computer program product accessible from a computer-usable or computer-readable medium (e.g., a non-transitory computer-readable medium) providing program code for use by or in connection with a computer or any instruction execution system, such as computer processor 28. For the purposes of this description, a computer-usable or computer readable medium can be any apparatus that can comprise, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Typically, the computer-usable or computer readable medium is a non-transitory computer-usable or computer readable medium.

Examples of a computer-readable medium include a semiconductor or solid state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-RAY) and DVD.

A data processing system suitable for storing and/or executing program code will include at least one processor (e.g., computer processor 28) coupled directly or indirectly to memory elements (e.g., memory 30) through a system bus. The memory elements can include local memory employed during actual execution of the program code, bulk storage, and cache memories which provide temporary storage of at least some program code in order to reduce the number of times code must be retrieved from bulk storage during execution. The system can read the inventive instructions on the program storage devices and follow these instructions to execute the methodology of the embodiments of the invention.

Network adapters may be coupled to the processor to enable the processor to become coupled to other processors or remote printers or storage devices through intervening private or public networks. Modems, cable modem and Ethernet cards are just a few of the currently available types of network adapters.

Computer program code for carrying out operations of the present invention may be written in any combination of one or more programming languages, including an object-oriented programming language such as Java, Smalltalk, C++ or the like and conventional procedural programming languages, such as the C programming language or similar programming languages.

It will be understood that algorithms described herein, can be implemented by computer program instructions. These computer program instructions may be provided to a processor of a general-purpose computer, special purpose computer, or other programmable data processing apparatus to produce a machine, such that the instructions, which execute via the processor of the computer (e.g., computer processor 28) or other programmable data processing apparatus, create means for implementing the functions/acts specified in the algorithms described in the present application. These computer program instructions may also be stored in a computer-readable medium (e.g., a non-transitory computer-readable medium) that can direct a computer or other programmable data processing apparatus to function in a particular manner, such that the instructions stored in the computer-readable medium produce an article of manufacture including instruction means which implement the function/act specified in the flowchart blocks and algorithms. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the algorithms described in the present application.

Computer processor 28 is typically a hardware device programmed with computer program instructions to produce a special purpose computer. For example, when programmed to perform the algorithms described herein, computer processor 28 typically acts as a special purpose sample-analysis computer processor. Typically, the operations described herein that are performed by computer processor 28 transform the physical state of memory 30, which is a real physical article, to have a different magnetic polarity, electrical charge, or the like depending on the technology of the memory that is used.

The apparatus and methods described herein may be used in conjunction with apparatus and methods described in any one of the following patents or patent applications, all of which are incorporated herein by reference:

U.S. Pat. No. 9,522,396 to Bachelet;

U.S. Pat. No. 10,176,565 to Greenfield;

U.S. Pat. No. 10,640,807 to Pollak;

U.S. Pat. No. 9,329,129 to Pollak;

U.S. Pat. No. 10,093,957 to Pollak;

U.S. Pat. No. 10,831,013 to Yorav Raphael;

U.S. Pat. No. 10,843,190 to Bachelet;

U.S. Pat. No. 10,482,595 to Yorav Raphael;

U.S. Pat. No. 10,488,644 to Eshel;

WO 17/168411 to Eshel;

US 2019/0302099 to Pollak;

US 2019/0145963 to Zait; and

WO 19/097387 to Yorav-Raphael.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. A method for use with a bodily sample that contains cells, the method comprising:
focusing a microscope such that a focal plane of the microscope at least approximately coincides with a level at which at least some cells belonging to the sample are at least partially disposed;
acquiring at least one on-focus microscopic image of the sample, while the focal plane of the microscope approximately coincides with the level;
focusing the microscope such that the focal plane of the microscope is offset with respect to the level;
acquiring at least one off-focus microscopic image of the sample, while the focal plane of the microscope is offset with respect to the level; and
determining a property of at least a portion of the sample, at least partially based upon the on-focus and off-focus images.

2. The method according to claim 1, wherein acquiring at least one off-focus microscopic image of the sample while the focal plane of the microscope is offset with respect to the level comprises acquiring at least one off-focus microscopic image of the sample while the focal plane of the microscope is offset with respect to the level by a predetermined offset.

3. The method according to claim 1, wherein determining a property of at least a portion of the sample at least partially based upon the on-focus and off-focus image comprises inputting the on-focus and off-focus image into a machine-learning classifier, the machine-learning classifier being configured to determine a property of at least a portion of the sample at least partially based upon the on-focus and off-focus image.

4. The method according to claim 1, wherein determining a property of at least a portion of the sample at least partially based upon the on-focus and off-focus image comprises deriving one or more parameters from the on-focus and off-focus image and inputting the one or more derived parameters into a machine-learning classifier, the machine-learning classifier being configured to determine a property of at least a portion of the sample at least partially based upon the derived parameters.

5. The method according to claim 1, wherein the sample includes a blood sample, and wherein acquiring at least one off-focus microscopic image of the sample while the focal plane of the microscope is offset with respect to the level comprises acquiring at least one off-focus microscopic image of the sample with the sample illuminated with light having a wavelength of between 505 nm and 535 nm.

6. The method according to claim 1, wherein the sample includes a blood sample, and wherein acquiring at least one off-focus microscopic image of the sample while the focal plane of the microscope is offset with respect to the level comprises acquiring at least one off-focus microscopic image of the sample with the sample illuminated with light having a wavelength of between 400 nm and 450 nm.

7. The method according to claim 1, wherein the sample includes a blood sample, and wherein acquiring at least one off-focus microscopic image of the sample while the focal plane of the microscope is offset with respect to the level comprises acquiring at least one off-focus microscopic image of the sample with the sample illuminated with light having a wavelength of between 620 nm and 640 nm.

8. The method according to claim 1, wherein focusing the microscope such that the focal plane of the microscope is offset with respect to the level comprises focusing the microscope such that the focal plane of the microscope is set closer to an objective lens of the microscope than the level at which at least some cells belonging to the sample are at least partially disposed.

9. The method according to claim 1, wherein focusing the microscope such that the focal plane of the microscope is offset with respect to the level comprises focusing the microscope such that the focal plane of the microscope is set farther from an objective lens of the microscope than the level at which at least some cells belonging to the sample are at least partially disposed.

10. The method according to claim 1, wherein focusing the microscope such that the focal plane of the microscope is offset with respect to the level comprises focusing the microscope such that the focal plane of the microscope is offset with respect to the level at which at least some cells belonging to the sample are at least partially disposed by between 20 microns and 100 microns.

11. The method according to claim 1, wherein focusing the microscope such that the focal plane of the microscope is offset with respect to the level comprises focusing the microscope such that the focal plane of the microscope is offset with respect to the level at which at least some cells belonging to the sample are at least partially disposed by between one and five depths of focus of the microscope.

12. The method according to claim 1, further comprising allowing some cells within the sample to settle such as to form a monolayer at a monolayer focus level, wherein focusing the microscope such that the focal plane of the microscope at least approximately coincides with a level at which at least some cells belonging to the sample are at least partially disposed comprises focusing the microscope such that the focal plane of the microscope at least approximately coincides with the monolayer focus level.

13. The method according to claim 1, further comprising allowing some cells within the sample to settle such as to form a monolayer at a monolayer focus level, with other cells within the sample suspended at at least one additional level within the sample, wherein focusing the microscope such that the focal plane of the microscope at least approximately coincides with a level at which at least some cells belonging to the sample are at least partially disposed comprises focusing the microscope such that the focal plane of the microscope at least approximately coincides with the additional level at which the other cells within the sample are suspended.

14. The method according to claim 1, wherein determining the property of the portion of the sample, at least partially based upon the on-focus and off-focus image comprises normalizing the on-focus and off-focus image with respect to each other and determining the property of the portion of the sample, at least partially based upon the normalization.

15. The method according to claim 1, wherein the sample includes a blood sample, and wherein determining the property of the portion of the sample at least partially based upon the on-focus and off-focus image comprises identifying one or more entities within the blood sample at least partially based upon the on-focus and off-focus image, the one or more entities selected from the group consisting of: a platelet, a leukocyte, a lymphocyte, a granulocyte, a monocyte, a neutrophil, a banded neutrophil, an eosinophil, a basophil, and a macrophage.

16. The method according to claim 1, wherein the sample includes a blood sample, and wherein determining the property of the portion of the sample at least partially based upon the on-focus and off-focus image comprises identifying a blast cell within the blood sample at least partially based upon the on-focus and off-focus image.

17. The method according to claim 1, wherein determining the property of the portion of the sample at least partially based upon the on-focus and off-focus image comprises identifying outlines of one or more entities within the sample at least partially based upon the on-focus and off-focus image.

18. The method according to claim 17, wherein determining the property of the portion of the sample at least partially based upon the on-focus and off-focus image further comprises estimating a parameter of the one or more entities at least partially based upon the identified outlines, the parameters selected from the group consisting of: cell area and cell volume.

19. The method according to claim 17, wherein determining the property of the portion of the sample at least partially based upon the on-focus and off-focus image further comprises estimating a parameter of sample at least partially based upon the identified outlines, the at least one parameter selected from the group consisting of: mean cell area and mean cell volume.

20. Apparatus for use with a bodily sample that contains cells, the apparatus comprising:
a microscope; and
a computer processor configured to:
focus the microscope such that a focal plane of the microscope at least approximately coincides with a level at which at least some cells belonging to the sample are at least partially disposed,
drive the microscope to acquire at least one on-focus microscopic image of the sample, while the focal plane of the microscope approximately coincides with the level,
focus the microscope such that the focal plane of the microscope is offset with respect to the level,
drive the microscope to acquire at least one off-focus microscopic image of the sample, while the focal plane of the microscope is offset with respect to the level, and
determine a property of at least a portion of the sample, at least partially based upon the on-focus and off-focus images.

21. A method for use with a bodily sample that contains cells, the method comprising:
focusing the microscope such that the focal plane of the microscope is offset with respect to a level at which at least some cells belonging to the sample are at least partially disposed;
acquiring at least one off-focus microscopic image of the sample, while the focal plane of the microscope is offset with respect to the level; and
at least partially based upon the off-focus image, performing one or more actions selected from the group consisting of: identifying an entity disposed within the level, determining outlines of an entity disposed within the level, determining a parameter of an entity disposed within the level, determining a parameter of the sample, and any combination thereof.

22-54. (canceled)
